(19) United States
(12) Patent Application Publication
(10) Pub. No.: US 2026/0126518 A1
(43) Pub. Date: May 7, 2026

(54) METHOD AND APPARATUS FOR PERFORMING RANGING USING UWB COMMUNICATION

(71) Applicant: SAMSUNG ELECTRONICS CO., LTD., Suwon-si (KR)

(72) Inventor: Gyubong OH, Suwon-si (KR)

(21) Appl. No.: 19/383,276

(22) Filed: Nov. 7, 2025

(30) Foreign Application Priority Data
Nov. 7, 2024 (KR) 10-2024-0157515

(51) Int. Cl. G01S 7/282; G01S 13/10

(52) U.S. Cl. CPC G01S 7/282; G01S 13/10

(57) ABSTRACT

Methods of providing a service by using ultra-wideband communication are disclosed. In one embodiment, a method of a first UWB device operating as a controller during UWB communication may include exchanging, with a second UWB device operating as a controlee, device capability information regarding multiple ranging rounds to be used when the first UWB device and the second UWB device perform UWB two-way ranging (TWR), transmitting, by the first UWB device, a command including a service configuration parameter or a session configuration parameter for the multiple ranging rounds to a UWB subsystem (UWBS) in the first UWB device through a UWB command interface (UCI), receiving, by the first UWB device, a response corresponding to the command from the UWBS in the first UWB device through the UCI, and performing UWB secure ranging with the second UWB device, based on the configuration parameter for the multiple ranging rounds.

### CROSS-REFERENCE TO RELATED APPLICATION

This application is based on and claims priority under 35 U.S.C. § 119 to Korean Patent Application No. 10-2024-0157515, filed on Nov. 7, 2024, in the Korean Intellectual Property Office, the disclosure of which is herein incorporated by reference in its entirety.

### BACKGROUND

### 1. Field

The disclosure relates to UWB communication and, more particularly, to a method and an apparatus for performing ranging using UWB communication.

### 2. Description of Related Art

The Internet, which is a human centered connectivity network where humans generate and consume information, is now evolving to the Internet of things (IoT) where distributed entities, such as things, exchange and process information. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation. Recently, a sensor network, a machine-to-machine (M2M) communication, machine type communication (MTC), and so forth have been researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

With the advance of wireless communication systems, various services can be provided, and accordingly there is a need for ways to effectively provide these services. For example, a ranging technology for measuring the distance between electronic devices by using an ultra-wideband (UWB) may be used.

### SUMMARY

The disclosure provides a multi-ranging method UWB communication.

A method of a first UWB device operating as a controller during UWB communication according to an embodiment of the disclosure may include exchanging, with a second UWB device operating as a controlee, device capability information regarding multiple ranging rounds to be used when the first UWB device and the second UWB device perform UWB two-way ranging (TWR), transmitting, by a framework in the first UWB device, a command including a service configuration parameter or a session configuration parameter for the multiple ranging rounds to a UWB subsystem (UWBS) in the first UWB device through a UWB command interface (UCI), receiving, by the framework in the first UWB device, a response corresponding to the command from the UWBS in the first UWB device through the UCI, and performing UWB secure ranging with the second UWB device, based on the configuration parameter for the multiple ranging rounds.

A method of a second UWB device operating as a controlee during UWB communication according to an embodiment may include exchanging, with a first UWB device operating as a controller, device capability information regarding multiple ranging rounds to be used when the first UWB device and the second UWB device perform UWB TWR, transmitting, by a framework in the second UWB device, a command including a service configuration parameter or a session configuration parameter for the multiple ranging rounds to a UWBS in the second UWB device through a UCI, receiving, by the framework in the second UWB device, a response corresponding to the command from the UWBS in the second UWB device through the UCI, and performing UWB secure ranging with the first UWB device, based on the configuration parameter for the multiple ranging rounds.

A first UWB device operating as a controller during UWB communication according to an embodiment may include a transceiver, and a controller. The controller is configured to exchange, with a second UWB device operating as a controlee, device capability information regarding multiple ranging rounds to be used when the first UWB device and the second UWB device perform UWB TWR, transmit, by a framework in the first UWB device, a command including a service configuration parameter or a session configuration parameter for the multiple ranging rounds to a UWBS in the first UWB device through a UCI, receive, by the framework in the first UWB device, a response corresponding to the command from the UWBS in the first UWB device through the UCI, and perform UWB secure ranging with the second UWB device, based on the configuration parameter for the multiple ranging rounds.

A second UWB device operating as a controlee during UWB communication according to an embodiment may include a transceiver, and a controller. The controller is configured to exchange, with a first UWB device operating as a controller, device capability information regarding multiple ranging rounds to be used when the second UWB device and the first UWB device perform UWM TWR, transmit, by a framework in the second UWB device, a command including a service configuration parameter or a session configuration parameter for the multiple ranging rounds to a UWBS in the second UWB device through a UCI), receive, by the framework in the second UWB device, a response corresponding to the command from the UWBS in the second UWB device through the UCI, and perform UWB secure ranging with the first UWB device, based on the configuration parameter for the multiple ranging rounds.

A method and an apparatus according to an embodiment of the disclosure may provide a UWB command interface for multi-ranging.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

The above and other aspects, features, and advantages of the disclosure will be more apparent from the following detailed description taken in conjunction with the accompanying drawings, in which:

FIG. 1 illustrates an exemplary architecture of a UWB device according to an embodiment of the disclosure;

FIG. 2 illustrates an exemplary configuration of a framework included in an electronic device of supporting a UWB-based service according to an embodiment of the disclosure;

FIG. 3 illustrates an example ranging block structure according to an embodiment of the disclosure;

FIG. 4 illustrates an example ranging block structure for UWB TWR using one ranging round according to an embodiment of the disclosure;

FIG. 5 illustrates an example ranging block structure for UWB TWR using two ranging rounds according to an embodiment of the disclosure;

FIG. 6 illustrates an example device structure for performing UWB ranging according to an embodiment of the disclosure;

FIG. 7 illustrates a flow diagram depicting an exchange of UWB messages according to an embodiment of the disclosure;

FIG. 8 illustrates a flow diagram depicting a UCI for multi-ranging in a controller according to an embodiment of the disclosure;

FIG. 9 illustrates a flow diagram depicting a UCI for multi-ranging in a controlee according to an embodiment of the disclosure;

FIG. 10 illustrates a structure of a first UWB device according to an embodiment of the disclosure; and

FIG. 11 illustrates a structure of a second UWB device according to an embodiment of the disclosure.

### DETAILED DESCRIPTION

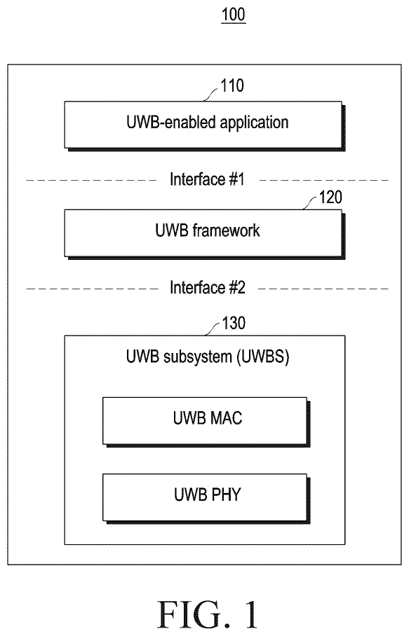

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various examples of the terminal may include a cellular phone, a smartphone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and playback home appliance having a wireless communication function, an Internet home appliance capable of wireless Internet access and browsing, and portable units or terminals having integrated combinations of these functions. Furthermore, the terminal may include a machine to machine (M2M) terminal, and a machine type communication (MTC) terminal/device, but is not limited thereto. As used herein, the terminal may also be referred to as an electronic device or simply as a device.

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, embodiments of the disclosure will be described in detail in conjunction with the accompanying drawings. In the following description of embodiments of the disclosure, a communication system using a UWB will be described by way of example, but the embodiments of the disclosure may be applied to other communication systems having similar technical backgrounds or characteristics. Examples of such communication systems may include communication systems using Bluetooth® or ZigBee®. Therefore, based on determinations by those skilled in the art, the embodiments of the disclosure may also be applied to other communication systems through some modifications without significantly departing from the scope of the disclosure.

Also, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In general, wireless sensor network technology is largely classified into wireless local area network (WLAN) technology and wireless personal area network (WPAN) technology according to recognition distance. The WLAN is a technology based on IEEE 802.11 that allows access to a backbone network within a radius of about 100 meters. The WPAN is a technology based on IEEE 802.15 and includes Bluetooth®, ZigBee®, and UWB communication. A wireless network implementing such wireless network technology may consist of multiple electronic devices.

According to the definition of the federal communications commission (FCC), UWB may refer to a wireless communication technology that uses a bandwidth of 500 MHz or more, or a bandwidth corresponding to 20% or more of a center frequency. The UWB may also refer to the band itself to which UWB communication is applied. The UWB enables secure and accurate ranging between devices. Accordingly, the UWB enables relative position estimation based on a distance between two devices, or accurate device position estimation based on a distance from fixed devices (with known positions).

The specific terms used in the following description are provided to help the understanding of the disclosure, and the use of such specific terms may be changed into other forms without departing from the technical spirit of the disclosure.

“Application dedicated file (ADF)” may be a data structure in an application data structure that can host, for example, an application or application specific data.

“Application protocol data unit (APDU)” may be a command and a response used when communicating with an application data structure in a UWB device.

“Application specific data” may be, for example, a file structure including a root level and an application level, the file structure including UWB controlee information and UWB session data required for a UWB session.

“Controller” may be a ranging device that defines and controls ranging control messages (RCM) (or control messages). The controller may define and control ranging features by transmitting control messages.

“Controlee” may be a ranging device that uses ranging parameters in an RCM (or control message) received from a controller. The controlee may use ranging features configured through control messages from the controller.

“Dynamic scrambled timestamp sequence (STS) mode” may be an operation mode in which an STS is not repeated during a ranging session, unlike “Static STS”. In this mode, the STS is managed by a ranging device, and a ranging session key for generating the STS may be managed by a secure component.

“Applet” may be an applet executed on a secure component and including, for example, UWB parameters and service data. The applet may be a FiRa applet.

“Ranging device” may be a device capable of performing UWB ranging. In the disclosure, the ranging device may be an enhanced ranging device (ERDEV) defined in IEEE 802.15.4z or a FiRa device. The ranging device may be referred to as a UWB device.

“UWB-enabled application” may be an application for a UWB service. For example, the UWB-enabled application may be an application for a UWB session that uses an out-of-band (OOB) connector, a secure service, and/or a framework API to configure a UWB service. The “UWB-enabled application” may be abbreviated as an application or a UWB application. The UWB-enabled application may be a FiRa-enabled application.

“Framework” may be a component that provides access to profiles, individual UWB configurations, and/or notifications. The framework may be, for example, a collection of logical software components including a profile manager, an OOB connector, a secure service, and/or a UWB service. The framework may be a FiRa framework.

“OOB connector” may be a software component for establishing an OOB connection (e.g., a BLE connection) between ranging devices. The OOB connector may be a FiRa OOB connector.

“Profile” may be a predefined set of UWB and OOB configuration parameters. The profile may be a FiRa profile.

“Profile manager” may be a software component implementing profiles available in a ranging device. The profile manager may be a FiRa profile manager.

“Service” may be an implementation of a use case that provides a service to an end-user.

“Smart ranging device” may be a ranging device capable of implementing an optional framework API. The smart ranging device may be a FiRa smart device.

“Global dedicated file (GDF)” may be the root level of application specific data, the root level including data required to establish a UWB session.

“Framework API” may be an API used by a UWB-enabled application to communicate with a framework.

“Initiator” may be a ranging device that initiates a ranging exchange. The initiator may initiate the ranging exchange by transmitting a first RFRAME (ranging exchange message).

“Object identifier (OID)” may be an identifier of an ADF in an application data structure.

“Out-of-band (OOB)” may be data communication that does not use UWB as an underlying wireless technology.

“Ranging data set (RDS)” may be data (e.g., a UWB session key, a session ID, etc.) required to establish a UWB session in which confidentiality, authenticity, and integrity need to be protected.

“Responder” may be a ranging device that responds to an initiator in a ranging exchange. The responder may respond to a ranging exchange message received from the initiator.

“STS” may be a ciphered sequence for increasing integrity and accuracy of ranging measurement timestamps. The STS may be generated from a ranging session key.

“Secure channel” may be a data channel that prevents overhearing and tampering.

“Secure component” may be an entity having a defined security level for interfacing with a UWBS for the purpose of providing an RDS to the UWBS, for example, when a dynamic STS is used (e.g., a secure element (SE) or a trusted execution environment (TEE)).

“SE” may be a tamper-resistant secure hardware component that can be used as a secure component in a ranging device.

“Secure ranging” may be ranging based on an STS generated through strong cryptographic operations.

“Secure service” may be a software component for interfacing with a secure component such as a secure element or a TEE.

“Service applet” may be an applet on a secure component that handles service-specific transactions.

“Service data” may be data defined by a service provider that needs to be delivered between two ranging devices in order to implement a service.

“Service provider” may be an entity that defines and provides hardware and software required to provide a specific service to an end-user.

“Static STS mode” may be an operation mode in which an STS is repeated during a session and does not need to be managed by a secure component.

“Secure UWB service (SUS) applet” may be an applet on an SE that communicates with another applet to retrieve data necessary to enable a secure UWB session with another ranging device. The SUS applet may also deliver the data (information) to a UWBS.

“UWB service” may be a software component that provides access to a UWBS.

“UWB session” may be a period from when a controller and a controlee start communication through UWB to the communication is terminated. The UWB session may include ranging, data delivery, or both ranging and data delivery.

“UWB session ID” may be an ID (e.g., a 32-bit integer) shared between a controller and a controlee to identify a UWB session.

“UWB session key” may be a key used to protect a UWB session. The UWB session key may be used to generate an STS. The UWB session key may be a UWB ranging session key (URSK) and may be abbreviated as a session key.

“UWB subsystem (UWBS)” may be a hardware component implementing UWB PHY and MAC layer (specifications). The UWBS may include an interface to a framework and an interface to a secure component for retrieving an RDS.

“UWB message” may be a message including a payload information element (IE) transmitted by a UWB device (e.g., an ERDEV).

“Payload IE” may be an IE included in a MAC payload of a UWB MAC frame. The MAC payload may include one or multiple payload IEs.

“Scheduled-based ranging” may be used for a ranging round in which controlees are scheduled by a controller to transmit a ranging frame (RFRAME) and/or a measurement report in different ranging slots. The scheduled-based ranging may also be referred to as time-scheduled ranging. A scheduling mode in which scheduled-based ranging is used may be referred to as a time-scheduled mode.

“Contention-based ranging” may be used when a controller does not know MAC addresses of controlees participating in a UWB session (ranging session). In contention-based ranging, the controller may be an initiator and may perform ranging with other unknown UWB devices. A scheduling mode in which contention-based ranging is used may be referred to as a contention-based mode.

The contention-based ranging may be used for a ranging round in which the controller determines a size of a contention access period (CAP) and notifies of the CAP size through a ranging control message. The CAP may also be referred to as a contention window or a contention window period.

In the contention-based mode, a UWB device may operate as a controller and an initiator, and in this case, a ranging control phase (RCP) and a ranging initiation phase (RIP) may be merged into one phase (e.g., the RIP). In a ranging phase (RP), allocation of the CAP size may determine CAP periods for responders participating in the ranging round in ranging slot units. Each responder may randomly determine one slot in the CAP to transmit a ranging response message (RRM). Messages used in the contention-based ranging may use SPI as an RFRAME configuration.

“Hybrid ranging” may be used when there are both known controlees and unknown controlees. As described above, a known controlee may be a controlee whose MAC address is known to a controller, and an unknown controlee may be a controlee whose MAC address is not known to the controller. The hybrid ranging may also be referred to as hybrid-based ranging. A scheduling mode in which hybrid ranging is used may be referred to as a hybrid-based mode.

In the hybrid-based mode, the controller may perform ranging with the known controlees in a scheduled-based mode and perform ranging with the unknown controlees in a contention-based mode.

In the hybrid-based mode, a ranging round may include a ranging control phase (RCP) and a ranging phase (RP). The RP may include a contention free period (CFP) for scheduled-based ranging (access) and a contention access period (CAP) for contention-based ranging (access). A control message (ranging control message) used in the RCP of the hybrid-based mode may be referred to as a ranging management message (RMM).

“AoA” may be an angle of arrival of a received signal and may be represented as relative angles such as an AoA azimuth and an AoA elevation. For example, it may be assumed that a measuring device is a mobile phone having a display, a Y-axis is a vertical display axis of the phone, an X-axis is a horizontal display axis of the phone, and a Z-axis is orthogonal to the phone display. In this case, an AoA azimuth angle may be a relative angle between an input signal projected on an XZ plane and the Z-axis, and an AoA elevation angle may be a relative angle between the input signal and the XZ plane.

In the case of TWR, a controller (initiator) may measure an AoA azimuth for an RRM and may transmit the measured AoA azimuth through a UCI notification message. A controlee (responder) may measure an AoA azimuth for an RIM message and may transmit the measured AoA azimuth through an RRM.

In the case of TWR, the controller (initiator) may measure an AoA elevation for an RRM and may transmit the measured AoA elevation through a UCI notification message. The controlee (responder) may measure an AoA elevation for an RIM message and may transmit the measured AoA elevation through an RRM.

In the case of a one-way ranging (OWR), an observer may measure an AoA azimuth and an AoA elevation for an AoA measurement message.

“Data message payload information element (DM payload IE)” may be a payload IE used to include data generated from an application, an applet, or another data source in a UWB message and transmit the same. In the disclosure, the data message payload IE may also simply be referred to as a data message. The data message payload IE may be combined with a ranging payload IE, as illustrated in FIG. 23, to become part of a PHY payload of the UWB message.

Data message payload IE may consist of, or include a portion of, a vendor OUI, a UWB message identifier (UWB message ID), a data message type (DM type), and a content field.

Depending on the data message type, the content field may include different types of messages. When a value of the data message type (DM type) field is 0x0, the content field may include general application data. The content field may further include a length of the delivered application data. The content field may also include, as a payload, a MAC data service data unit (MDSDU), which is data generated in an upper layer of a MAC layer of a UWB subsystem and delivered to the MAC.

When a value of the data message type (DM type) field of the data message payload IE is 0x1, the content field may include a data transfer phase control message (DTPCM).

In the description of the disclosure, detailed descriptions of related known functions or configurations that may unnecessarily obscure the gist of the disclosure will be omitted.

Hereinafter, various embodiments of the disclosure will be described with reference to the accompanying drawings.

FIG. 1 illustrates an exemplary architecture of a UWB device according to an embodiment of the disclosure.

The UWB device 100 may be an electronic device supporting UWB communication. The UWB device 100 may be, for example, a ranging device supporting UWB ranging. In an embodiment, the ranging device may be an enhanced ranging device (ERDEV) defined in IEEE 802.15.4z or a FiRa device.

In the embodiment of FIG. 1, the UWB device 100 may interact with another UWB device through a UWB session.

In addition, the UWB device 100 may implement a first interface (interface #1), which is an interface between a UWB-enabled application 110 and a UWB framework 120. The first interface allows the UWB-enabled application 110 on the UWB device 100 to use UWB functions of the UWB device 100 in a predetermined manner. In an embodiment, the first interface may be a framework API or a proprietary interface, but is not limited thereto.

Furthermore, the UWB device 100 may implement a second interface (interface #2), which is an interface between a UWB framework 120 and a UWBS 130. In an embodiment, the second interface may be a UWB command interface (UCI) or a proprietary interface, but is not limited thereto.

Referring to FIG. 1, the UWB device 100 may include a UWB-enabled application 110, a framework (UWB framework) 120, and a UWBS 130 including a UWB MAC layer and a UWB physical layer. Depending on embodiments, some entities may not be included in the UWB device, or additional entities (e.g., a security layer) may be further included.

The UWB-enabled application 110 may trigger establishment of a UWB session by the UWBS 130 through the first interface. Further, the UWB-enabled application 110 may use one of predefined profiles. The UWB-enabled application 110 may handle related events, such as service discovery, ranging notifications, and/or error conditions, by using the first interface.

The UWB framework 120 may provide access to profiles, individual-UWB configurations, and/or notifications. Further, the UWB framework 120 may support at least one of a function for UWB ranging and transaction execution, a function to provide an interface to the application and the UWBS 130, or a function to estimate the position of the device 100. The UWB framework 120 may be a set of software components. As described above, the UWB-enabled application 110 may interface with the UWB framework 120 through the first interface, and the UWB framework 120 may interface with the UWBS 130 through the second interface.

Meanwhile, in the disclosure, the UWB-enabled application 110 and/or the UWB framework 120 may be implemented by an application processor (AP) (or processor). Accordingly, in the disclosure, operations of the UWB-enabled application 110 and/or the UWB framework 120 may be understood to be performed by the AP (or processor). In the disclosure, the UWB framework 120 may be referred to as an AP, a processor, or a host.

The UWBS 130 may be a hardware component including a UWB MAC layer and a UWB physical layer. The UWBS 130 may perform UWB session management and may communicate with a UWBS of another UWB device. The UWBS 130 may interface with the UWB framework 120 through the second interface and may acquire secure data from a secure component. In an embodiment, the UWB framework (or application processor) 120 may transmit a command to the UWBS 130 through a UCI, and the UWBS 130 may deliver a response to the command to the framework 120. The UWBS 130 may also deliver a notification to the UWB framework 120 through the UCI.

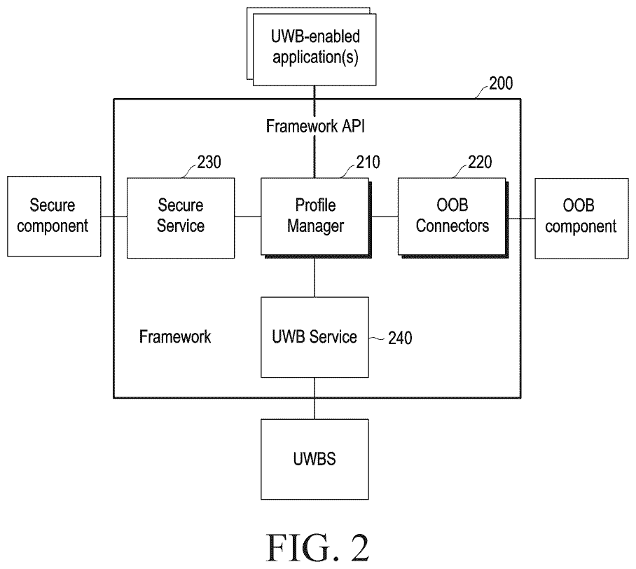

FIG. 2 illustrates an exemplary configuration of a framework 200 included in an electronic device supporting a UWB-based service according to an embodiment of the disclosure.

The framework 200 of FIG. 2 may be an example of the UWB framework 120 of FIG. 1. The framework 200 of FIG. 2 may also be referred to as a host.

The framework 200 may be a set of logical software components. A UWB-enabled application may interface with the framework through a framework API provided by the framework 200.

Referring to FIG. 2, the framework 200 may include a profile manager 210, OOB connectors 220, a secure service 230, and/or a UWB service 240. However, depending on embodiments, some components may be omitted or additional components may be further included.

The profile manager component 210 may manage profiles available on a ranging device (UWB device). A profile may be a set of parameters used to establish a successful UWB session between ranging devices (UWB devices). For example, the profile may include a parameter indicating which secure channel (e.g., an OOB secure channel) is used, a UWB/OOB configuration parameter, a parameter indicating whether the use of a specific secure component is mandatory, and/or a parameter related to the file structure of an ADF. In addition, the profile manager may abstract UWB and OOB configuration parameters from a UWB-enabled application.

The OOB connector component 220 may be a component for establishing an OOB connection between ranging devices (UWB devices).

The secure service component 230 may perform a role of interfacing with a secure component such as a secure element (SE) or a trusted execution environment (TEE). The secure component may be a component interfacing with a UWBS to deliver UWB ranging data to the UWBS.

The UWB service component 240 may be a component providing access to a UWBS.

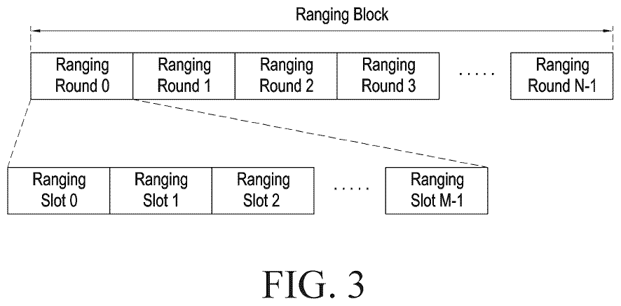

FIG. 3 illustrates an example ranging block structure according to an embodiment of the disclosure.

Referring to FIG. 3, one ranging block may include at least one ranging round, and each ranging round may include at least one ranging slot. For example, as illustrated, one ranging block may include N ranging rounds (e.g., ranging round 0 to ranging round index (N−1)), and the ranging round #0 may include M ranging slots (e.g., ranging slot 0 to ranging slot (M−1)).

A ranging block may refer to a time period for ranging. A ranging round may be a period of sufficient duration to complete an entire range-measurement cycle (ranging cycle) in which a set of ranging devices participating in a ranging exchange is involved. A ranging slot may be a sufficient duration for transmitting at least one ranging frame (RFRAME) (e.g., a ranging initiation/response/final message, etc.).

Meanwhile, when a ranging mode is a block-based mode, a mean time between consecutive ranging rounds may be constant. Alternatively, when a ranging mode is an interval-based mode, a time between consecutive ranging rounds may be dynamically changed. That is, the interval-based mode may adopt a time structure having adaptive spacing.

In the disclosure, a ranging block may be also referred to as a block, a ranging round may be also referred to as a round, and a ranging slot may be also referred to as a slot.

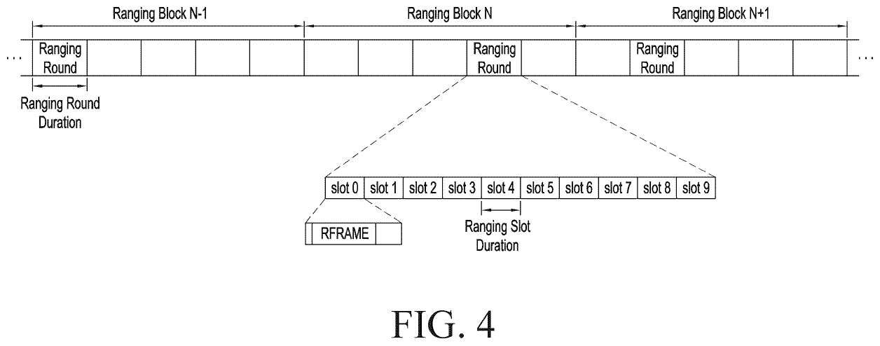

FIG. 4 illustrates an example ranging block structure for a UWB TWR using one ranging round according to an embodiment of the disclosure.

Referring to FIG. 4, multiple ranging blocks (e.g., ranging block (N−1), ranging block N, and ranging block (N+1)) for UWB TWR may be configured, and a plurality of UWB devices may perform UWB TWR in each of the multiple ranging blocks (e.g., ranging block (N−1), ranging block N, and ranging block (N+1)) by using one ranging round. One ranging round may be configured as a time period of a ranging round duration on a time axis. According to an embodiment, the plurality of UWB devices may transmit and/or receive at least one message (e.g., at least one of Pre-Poll, Poll, Response, Final, and Final_Data) for car connectivity consortium (CCC) UWB TWR by using one ranging round.

Each ranging round may include, for example, 10 ranging slots. One ranging slot may be configured as a time period of a ranging slot duration on the time axis. The ranging slot may be a sufficient duration for transmitting at least one ranging frame (RFRAME).

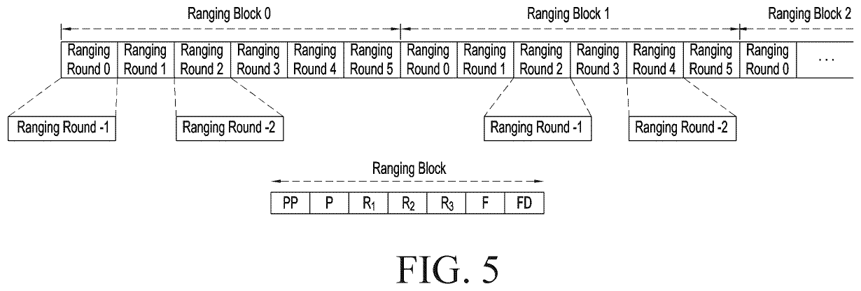

FIG. 5 illustrates an example ranging block structure for a UWB TWR using two ranging rounds according to an embodiment of the disclosure.

Referring to FIG. 5, multiple ranging blocks (e.g., ranging block 0 to ranging block 2) for UWB TWR may be configured, and a plurality of UWB devices may perform UWB TWR in each of the multiple ranging blocks (e.g., ranging block 0 to ranging block 2) by using two ranging rounds. One ranging round may be configured as a time period of a ranging round duration on a time axis. In FIG. 5, for convenience of explanation, an embodiment in which the UWB devices perform UWB TWR in each of the multiple ranging blocks (e.g., ranging block 0 to ranging block 2) by using two ranging rounds is illustrated, but the UWB devices may perform UWB TWR in each of the multiple ranging blocks (e.g., ranging block 0 to ranging block 2) by using three or more ranging rounds.

For example, the plurality of UWB devices may perform UWB TWR in the ranging block 0 by using ranging round 0 and ranging round 2. For example, the plurality of UWB devices may perform UWB TWR in the ranging block 1 by using ranging round 2 and ranging round 4.

According to an embodiment, the plurality of UWB devices may transmit and/or receive at least one message (e.g., at least one of a pre-poll message, a poll message, a response message, a final message, and a final_data message) for CCC UWB TWR by using two ranging rounds. For example, one ranging round may include a PP section for transmitting and receiving a pre-poll message, a P section for transmitting and receiving a poll message, R1 to R3 sections for transmitting and receiving a plurality of response messages, an F section for transmitting and receiving a final message, and an FD section for transmitting and receiving a final_data message.

In embodiments described later in the disclosure, a method for providing UWB session setup and UWB configuration parameter settings when performing UWB TWR (or Aliro UWB TWR) using a plurality of (e.g., two) ranging rounds will be proposed.

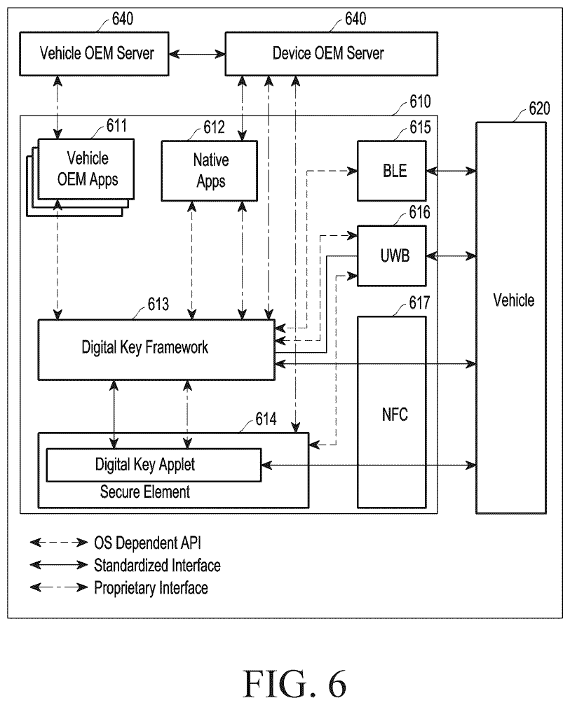

FIG. 6 illustrates an example device structure for performing UWB ranging according to an embodiment of the disclosure.

Referring to FIG. 6, a UWB ranging device 610 may provide a specific service (e.g., access control to a vehicle 620 using a digital key) to a vehicle 620 through BLE and/or UWB communication. The UWB ranging device 610 may communicate with a vehicle original equipment manufacturer (OEM) server 630 and/or a device OEM server 640.

The UWB ranging device 610 may include at least one of a vehicle OEM application 611, a native application 612, a digital key framework 613, a secure element 614 including a digital key applet, a BLE module 615 supporting BLE communication, a UWB module 616 supporting UWB communication, and a near-filed communication (NFC) module 617 supporting NFC communication.

In the disclosure, a method of providing a UCI between the digital key framework 613 and the UWB module 616 for multi-ranging is described.

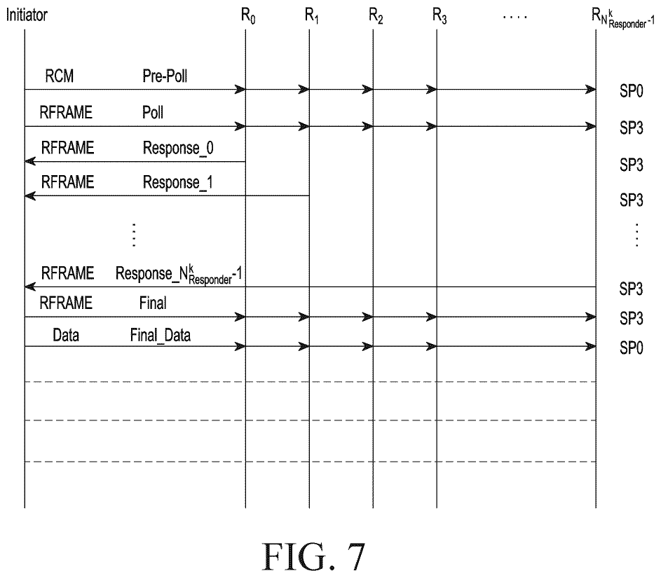

FIG. 7 illustrates a flow diagram depicting an exchange of UWB messages according to an embodiment of the disclosure.

Referring to FIG. 7, a first UWB device (initiator) may exchange UWB messages with a plurality of UWB devices (responder 0 to responder (Nk−1)) in an s-th ranging round within an i-th ranging block.

The first UWB device (initiator) may transmit an RCM (or pre-poll message) including parameters for controlling UWB ranging to the plurality of UWB devices (responder 0 to responder (Nk−1)).

The first UWB device (initiator) may transmit an RFRAME (or poll message) to the plurality of UWB devices (responder 0 to responder (Nk−1)), and in response to the RFRAME (or poll message), each of the plurality of UWB devices (responder 0 to responder (Nk−1)) may transmit an RFRAME (or response message) to the first UWB device (initiator).

The first UWB device (initiator) may transmit an RFRAME (or final message) to the plurality of UWB devices (responder 0 to responder (Nk−1)). The first UWB device (initiator) may transmit data (or a final_data message) to each of the plurality of UWB devices (responder 0 to responder (Nk−1)).

In the case of conventional CCC UWB TWR, a ranging session may be configured by one ranging round within one ranging block. In the disclosure, a method for establishing a UWB session setup and application configuration parameters (APP configuration parameters) for configuring a plurality of (e.g., two) ranging rounds for UWB TWR is described.

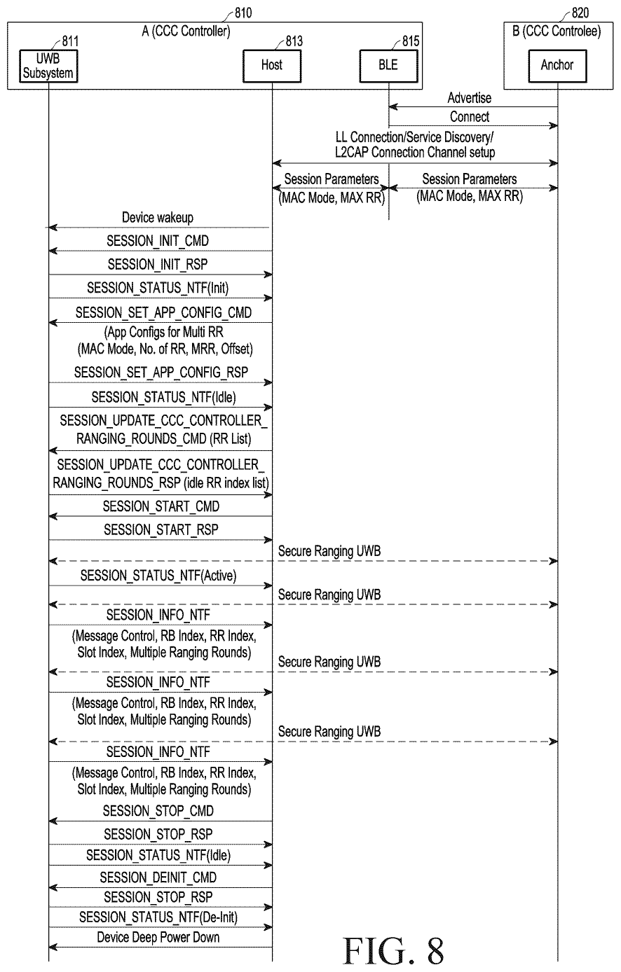

FIG. 8 illustrates a flow diagram depicting a UCI for multi-ranging in a controller according to an embodiment of the disclosure.

Referring to FIG. 8, a first UWB device (controller) 810 may include a UWB subsystem (UWBS) 811, a host (or framework) 813, and a BLE module 815.

A second UWB device (controlee) 820 including an anchor may transmit, to the first UWB device (controller) 810, an advertisement message including a UWB service ID (e.g., a CCC digital key or Aliro) and information used for the service (e.g., a reader group ID), and the BLE module 815 may deliver, to the second UWB device (controlee) 820, a message (“connect”) requesting the BLE connection. The first UWB device (controller) 810 and the second UWB device (controlee) 820 may establish a link layer connection and may subsequently sequentially perform service discovery and generate an L2CAP connection channel.

The BLE module 815 and the second UWB device (controlee) 820 may exchange session parameters (e.g., MAC mode, MAX ranging round (RR)) used for UWB ranging session setup through negotiation scheme, in the form of ranging session setup request/response messages, and the BLE module 815 and the host (or framework) 813 may also deliver or exchange session parameters (e.g., MAC mode, MAX RR).

According to an embodiment, the first UWB device (controller) 810 and the second UWB device (controlee) 820 may exchange device capability parameters in order to use multiple ranging rounds (MRR) during UWB TWR. According to an embodiment, the device capability parameters may include at least one of the parameters in Table 1.

TABLE 1

| | Length | Tag | |
|---|---|---|---|
| Parameter Name | (octets) | (IDs) | Description |
| CCC_CONTROLLER_MAX_RR | 1 | 0xA8 | Maximum number of Multiple |
| | | | ranging rounds supported by |
| | | | the device when acting as CCC |
| | | | Controller. Values can range |
| | | | from 0 to 255. A zero value |
| | | | means that the device does not |
| | | | support the CCC Controller |
| | | | device role. |
| | | | This field shall be 0 if bit b2 |
| | | | (CCC Controller) of |
| | | | DEVICE_TYPE capability |
| | | | parameter is 0. |
| CCC_CONTROLEE_MAX_RR | 1 | 0xA9 | Maximum number of Multiple |
| | | | ranging rounds supported by |
| | | | the device when acting as CCC |
| | | | Controlee. Values can range |
| | | | from 0 to 255. A zero value |
| | | | means that the device does not |
| | | | support the CCC Controlee |
| | | | device role. |
| | | | This field shall be 0 if bit b3 |
| | | | (CCC Controlee) of |
| | | | DEVICE_TYPE capability |
| | | | parameter is 0. |
| RFU | 1 | 0XAC- | RFU |
| | | 0xAF | |

The parameter names and descriptions of Table 1 may, if appropriate, be changed into forms such as ALIRO_CONTROLLER_MAX_RR. Since the current Aliro UWB standard follows the CCC UWB standard, the UCI standard for session setup/management to be described later has also been defined in terms of extension of the existing CCC UWB session setup/management, and the parameter names have used the prefix “CCC.” When Aliro UWB session setup/management is separately defined, not only the parameter names in Table 1 but also related commands and parameters to be described later may use “Aliro” as a prefix instead of “CCC.”

In addition, when the UWB secure ranging between the first UWB device (controller) 810 and the second UWB device (controlee) 820 described in FIG. 7 is performed in the form of multiple ranging rounds, the vendor OUI in the vendor-specific header IE of the MAC header (MHR), in the case of SP0 UWB messages such as pre-poll SP0 and final_data SP0, may use a CSA OUI value (0x4A191B) in an actual commercial service environment, as Aliro UWB follows the CCC UWB standard. When performing functional testing or verification of Aliro UWB TWR using UCI, a CCC OUI value (0x04DF69) may also be used for testing or verification.

The host (or framework) 813 may transmit a device wakeup message to the UWBS 811 to wake up the UWBS 811. The host (or framework) 813 may transmit a session initialization command (SESSION_INIT_CMD) to the UWBS 811, and the UWBS 811 may transmit a session initialization response (SESSION_INIT_RSP) to the host (or framework) 813.

The UWBS 811 may transmit a message (SESSION_STATUS_NTF(init)) regarding a session status to the host (or framework) 813, and the host (or framework) 813 may transmit a command (SESSION_SET_APP_CONFIG_CMD) regarding session and application configuration to the UWBS 811. According to an embodiment, the command (SESSION_SET_APP_CONFIG_CMD) regarding session and application configuration may include application configuration information for multiple ranging rounds (RRs). According to an embodiment, the command (SESSION_SET_APP_CONFIG_CMD) regarding session and application configuration may include at least one of a MAC mode, the number of RRs, information on multiple ranging rounds (MRR), and an offset. The UWBS 811 may transmit a response (SESSION_SET_APP_CONFIG_RSP) regarding session and application configuration to the host (or framework) 813.

According to an embodiment, application configuration parameters for use of MRR during UWB TWR may be configured. According to an embodiment, the first UWB device (controller) 810 and/or the second UWB device (controlee) 820 may add associated parameters for MRR when configuring a CCC service. According to an embodiment, the first UWB device (controller) 810 may configure the number of ranging rounds used for use of MRR during UWB TWR, and may transmit the MRR information to the second UWB device (controlee) 820. In this case, an offset may be configured to prevent ranging conflict with another session and to eliminate interference between ranging rounds.

According to an embodiment, the application configuration parameters for use of MRR during UWB TWR may include at least one of the parameters listed in Table 2.

TABLE 2

| | Length | Tag | |
|---|---|---|---|
| Parameter Name | (octets) | (IDs) | Description |
| CCC_MAC_Mode | 1 | 0xA9 | Number of ranging rounds (b7-b6) and the offset |
| | | | between the two ranging rounds (b5-b0) out of all |
| | | | the ranging rounds in a ranging block, |
| | | | respectively |
| | | | b5-b0 = value range 1 to (number of ranging |
| | | | rounds) − 1. This will be set if [b7-b6] is set to 1. |
| | | | Otherwise, RFU and set to 0 |
| | | | b7-b6 = 0 and 1 for 1 and 2 ranging rounds, 2 and |
| | | | 3 for RFU |
| | | | default = 0x00, which means 1 ranging round |
| | | | only, so offset is not applicable |
| CCC_MULTIPLE_{—} | | 0XAB | 0x00 = Multiple ranging rounds information is |
| RANGING_ROUNDS | | | not present in Pre-Poll or Final_Data (default) |
| | | | 0x01 = Multiple ranging rounds information is |
| | | | present in Pre-Poll or Final_Data |
| | | | The CCC_NUMBER_OF_RAGING_ROUNDS |
| | | | parameter shall be configured by Host when |
| | | | CCC_MAC_MODE is set to other than 0x00. |
| | | | This configuration is only applicable when |
| | | | DEVICE_TYPE = 0xA0 (CCC Controller |
| | | | (Device) or 0xA1 (CCC Controlee (Vehicle)). |
| CCC_RANGING_{—} | 1 | 0XAC | Ranging Rounds offset (N) |
| ROUNDS_OFFSET | | | 1 ≤ N ≤ 254 (Default is 1) |
| | | | The CCC_RANGING_ROUNDS_OFFSET |
| | | | parameter shall be configured by Host when |
| | | | CCC_MULTIPLE_RANGING_ROUNDS is set |
| | | | to other than 0x00. |
| | | | This configuration is only applicable when |
| | | | DEVICE_TYPE = 0xA0 (CCC Controller |
| | | | (Device) or 0xA1 (CCC Controlee (Vehicle)). |
| RFU | 1 | 0XAD- | RFU |
| | | 0xAF | |

The application configuration parameters for use of MRR during UWB TWR may be defined, as shown in Table 2, by simultaneously defining the MAC mode and the number of RRs within a single parameter by bitwise partitioning of CCC_MAC_Mode, or may be defined, as shown in Table 3, by including the MAC mode and the number of RRs as separate parameters.

According to an embodiment, the application configuration parameters for use of MRR during UWB TWR may include at least one of the parameters listed in Table 3.

TABLE 3

| | Length | Tag | |
|---|---|---|---|
| Parameter Name | (octets) | (IDs) | Description |
| CCC_MAC_Mode | 1 | 0xA9 | Number of Ranging rounds |
| | | | 0x00 = multiple ranging rounds is |
| | | | not enabled (default) |
| | | | 0x01 = multiple ranging rounds is |
| | | | enabled |
| | | | This configuration is only applicable |
| | | | when DEVICE_TYPE = 0xA0 (CCC |
| | | | Controller (Device) or 0xA1 (CCC |
| | | | Controlee (Vehicle)). |
| CCC_NUMBER_{—} | 1 | 0xAA | Number of Raging Rounds (N) |
| OF_RANGING_{—} | | | 1 ≤ N ≤ 255 (Default is 1) |
| ROUNDS | | | The |
| | | | CCC_NUMBER_OF_RAGING_ROUNDS |
| | | | parameter shall be |
| | | | configured by Host when |
| | | | CCC_MAC_MODE is set other |
| | | | than 0x00. |
| | | | This configuration is only applicable |
| | | | when DEVICE_TYPE = 0xA0 (CCC |
| | | | Controller (Device) or 0xA1 (CCC |
| | | | Controlee (Vehicle)). |
| CCC_MULTIPLE_{—} | | 0XAB | 0x00 = Multiple ranging rounds |
| RANGING_ROUNDS | | | information is not present in Pre- |
| | | | Poll or Final_Data (default) |
| | | | 0x01 = Multiple ranging rounds |
| | | | information is present in Pre-Poll or |
| | | | Final_Data |
| | | | The |
| | | | CCC_NUMBER_OF_RAGING_ROUNDS |
| | | | parameter shall be |
| | | | configured by Host when |
| | | | CCC_MAC_MODE is set to other |
| | | | than 0x00. |
| | | | This configuration is only applicable |
| | | | when DEVICE_TYPE = 0xA0 (CCC |
| | | | Controller (Device) or 0xA1 (CCC |
| | | | Controlee (Vehicle)). |
| CCC_RANGING_{—} | 1 | 0XAC | Ranging Rounds offset (N) |
| ROUNDS_OFFSET | | | 1 ≤ N ≤ 254 (Default is 0) |
| | | | The |
| | | | CCC_RANGING_ROUNDS_OFFSET |
| | | | parameter shall be configured |
| | | | by Host when |
| | | | CCC_MULTIPLE_RANGING_ROUNDS |
| | | | is set to other than 0x00. |
| | | | This configuration is only applicable |
| | | | when DEVICE_TYPE = 0xA0 (CCC |
| | | | Controller (Device) or 0xA1 (CCC |
| | | | Controlee (Vehicle)). |
| RFU | 1 | XAD- | RFU |
| | | 0xAF | |

The UWBS 811 may transmit a message (SESSION_STATUS_NTF(idle)) regarding a session status to the host (or framework) 813. The host (or framework) 813 may transmit a command (SESSION_UPDATE_CCC_CONTROLLER_RANGING_ROUNDS_CMD) regarding session update and controller ranging rounds to the UWBS 811. According to an embodiment, the command (SESSION_UPDATE_CCC_CONTROLLER_RANGING_ROUNDS_CMD) regarding session update and controller ranging rounds may include an RR list. The UWBS 811 may transmit a response (SESSION_UPDATE_CCC_CONTROLLER_RANGING_ROUNDS_RSP) regarding session update and controller ranging rounds to the host (or framework) 813.

According to an embodiment, the command of a session update message of a CCC controller for multiple ranging rounds (MRR) may include slot scheduling information for a responder in the corresponding ranging round. According to an embodiment, the first UWB device (controller) 810 may be able to move to the corresponding RR upon occurrence of a hopping condition, based on idle ranging round information included in a response.

According to an embodiment, the first UWB device (controller) 810 may transmit ranging rounds (RR) list information to the second UWB device (controlee) 820 through UWB messages (e.g., pre-poll or final_data) or a BLE OOB data transfer.

According to an embodiment, the command (SESSION_UPDATE_CCC_CONTROLLER_RANGING_ROUNDS_CMD) regarding session update and controller ranging rounds may include at least one of the fields listed in Table 4.

TABLE 4
SESSION_UPDATE_CCC_CONTROLLER_RANGING_ROUNDS_CMD

| Payload | | | | | |
|---|---|---|---|---|---|
| Field(s) | Length | Value/Description | | | |
| Session | 4 Octets | Session Handle of the CCC session whose multiple ranging rounds are | | | |
| Handle | | to be activated. | | | |
| Number | 1 Octet | Number of ranging rounds (N) in which a UWBS is acting as CCC | | | |
| of | | Controller. Values can be 1 ≤ N ≤ CCC_CONTROLLER MAX RR. | | | |
| Ranging | | | | | |
| Rounds | | | | | |
| Ranging | Variable | Round Index | 1 | Octet | Ranging Round Index to activate |
| Rounds | | Number of | 0/1 | Octet | Number M of Responder MAC |

| | | | |
|---|---|---|---|
| List | Responders | | Addresses. Possible values are 1 ≤ M ≤ 10. |
| | Responder | 0/2/8 * | Responder MAC Address List for the |
| | MAC Address | M | specified ranging round as CCC Controlee. |
| | List | Octets | The MAC_ADDRESS_MODE parameter |
| | | | determines whether to use short (2 octets) |
| | | | or extended (8 octets) MAC addresses. |

| Responder | 0/1 | Octet | Responder slot presence |
|---|---|---|---|
| Slot | | | 0x00 = sequential slot scheduling; Slot |
| Scheduling | | | will be assigned by the order of the |
| | | | Responder MAC Address list |
| | | | 0x01 = fixed slot scheduling: Slot will |
| | | | be assigned with the fixed slot index for |
| | | | each Responder device |
| | | | 0x02-0xFF = RFU |
| Responder | 0/M | Octets | Slot indexes for each Responder device |

| | |
|---|---|
| Slots | in Responder MAC Address List |

According to an embodiment, the response (SESSION_UPDATE_CCC_CONTROLLER_RANGING_ROUNDS_RSP) regarding update and controller ranging rounds may include at least one of the fields listed in Table 5.

TABLE 5
SESSION_UPDATE_CCC_CONTROLLER_RANGING_ROUNDS_RSP

| Payload | | | |
|---|---|---|---|
| Field(s) | Length | | Value/Description |
| Status | 1 | Octet | STATUS_OK for success |
| Number of | 1 | Octet | Number of ranging rounds (N) that could be idle. This value |
| idle Ranging | | | should be set to 0x00 if the Status field of the response is |
| Rounds | | | STATUS_OK. |
| | | | Values can be 0 ≤ N ≤ 255 |
| Idle Ranging | N | Octets | List of the N Ranging Round indexes that could be idle |

Round
Indexes

The host (or framework) 813 may transmit a command (SESSION_START_CMD) instructing a session start to the UWBS 811, and the UWBS 811 may transmit a response (SESSION_START_RSP) instructing a session start to the host (or framework) 813.

The first UWB device (controller) 810 may perform UWB secure ranging with the second UWB device (controlee) 820, as described with reference to FIG. 7, in the form of multiple ranging rounds by using the UWBS 811 through the application configuration and session update. The UWBS 811 may transmit a message (SESSION_STATUS_NTF(active)) regarding a session status to the host (or framework) 813 upon a session status change from idle to active.

The first UWB device (controller) 810 may perform UWB secure ranging in the form of MRR with the second UWB device (controlee) 820 by using the UWBS 811. The UWBS 811 may transmit session information notification (SESSION_INFO_NTF), including ranging result values of the CCC controller shown in Table 6, to the host (or framework) 813. According to an embodiment, the session information notification (SESSION_INFO_NTF) may include at least one of message control, a ranging block (RB) index, a ranging round (RR) index, a ranging slot index, and information on multiple ranging rounds (MRR).

If appropriate, the first UWB device (controller) 810 may perform UWB secure ranging in the form of MRR with the second UWB device (controlee) 820 a plurality of times by using the UWBS 811, and the UWBS 811 may transmit, a plurality of times, a session information notification (SESSION_INFO_NTF) including the ranging result values of the CCC controller to the host (or framework) 813.

According to an embodiment, when multiple ranging rounds (MRR) are used during UWB secure ranging, the first UWB device (controller) 810 may transmit a ranging measurement message to a counterpart device, the message further including message control containing the number of MRR indexes, a next participating ranging block index, and an MRR index list. The second UWB device (controlee) 820 may transmit a ranging measurement message to a counterpart device, the message further including a next participating ranging block index.

According to an embodiment, the ranging measurement message of the first UWB device (controller) 810 may include at least one of the fields listed in Table 6.

TABLE 6
CCC Controller Ranging Measurement

| Payload | | | |
|---|---|---|---|
| Field(s) | Length | | Value/Description |
| Status | 1 | Octet | Ranging Status of each responder. |
| | | | For various status values refer Table for status codes. |
| | | | If status field is other than STATUS_OK , then all other values |
| | | | except Slot Index shall be ignored |
| Message | 2 | Octets | b0-b3: Number of multiple ranging round indexes of CCC |
| Control | | | Controller included in the measurement result as obtained from the |
| | | | received CCC UWB Message. If 0b0000, no multiple ranging round |
| | | | information is included in the result. This list shall not include the |
| | | | current ranging round index associated to the measurement result. |
| | | | 0b4-0b15 = RFU |
| Slot | 1 | Octet | Slot index of the responder. |
| Index | | | In case of a failure, this field indicates the slot number within the |
| | | | ranging round where the failure has occurred. Slot number starts |
| | | | from zero. |
| | | | Note: The Slot Index field is ignored by the host when Status is set |
| | | | to STATUS_OK and it may be set to value 0xFF by the UWBS when |
| | | | STATUS_OK or other error status where Slot Index is not |
| | | | applicable. |
| RR | 2 | Octets | Next Ranging Round Index |
| Index | | | |
| STS | 4 | Octets | STS index of the final frame |
| Index | | | |
| Block | 2 | Octets | Next Ranging Block Index |
| Index | | | |
| Multiple | M | Octets | List of M multiple ranging round indexes in which the CCC |

| | |
|---|---|
| Ranging | Controller associated to this measurement result is present. The |
| Rounds | number of M multiple ranging rounds is indicated in the Message |
| | Control field of the measurement result. |
| | This list is reported by the CCC Controller in the Multiple Ranging |
| | Round information field of either Pre-Poll or Final_Data. |

According to an embodiment, the ranging measurement message of the second UWB device (controlee) 820 may include at least one of the fields listed in Table 7.

TABLE 7
CCC Controlee Ranging Measurement

| Payload | | | |
|---|---|---|---|
| Field(s) | Length | | Value/Description |
| Status | 1 | Octet | For various status values refer Table for status codes. |
| | | | If status field is other than STATUS_OK or |
| | | | STATUS_OK_NEGATIVE_DISTANCE_REPORT, then all |
| | | | other values except Slot Index shall be ignored |
| Slot Index | 1 | Octet | In case of a failure, this field indicates the slot number within |
| | | | the ranging round where the failure has occurred. Slot number |
| | | | starts from zero. |
| RR Index | 2 | Octets | Next Ranging Round Index |
| STS Index | 4 | Octets | STS index received in final data message |
| Distance | 2 | Octets | Distance in centimeters. |
| | | | Speed of light in air value to be used in distance calculation is |
| | | | 299,702,547 m/s. |
| | | | If UWBS is unable to calculate distance, then this field is set to |
| | | | 0xFFFF |
| Uncertainty | 1 | Octets | Ranging timestamp uncertainty of controlee, |
| Anchor | | | Value range |
| (FoM) | | | |
| Uncertainty | 1 | Octets | Ranging timestamp uncertainty of controller |
| Initiator | | | Value range |
| (FoM) | | | |
| Block Index | 2 | Octets | Next Ranging Block Index |
| RFU | 12 | Octets | Reserved for future use. |

The host (or framework) 813 may transmit a command (SESSION_STOP_CMD) instructing a session stop to the UWBS 811, and the UWBS 811 may transmit a response (SESSION_STOP_RSP) regarding the session stop to the host (or framework) 813.

The UWBS 811 may transmit a message (SESSION_STATUS_NTF(idle)) regarding a session status to the host (or framework) 813. The host (or framework) 813 may transmit a session de-initialization command (SESSION_DEINIT_CMD) to the UWBS 811, and the UWBS 811 may transmit a response (SESSION_DEINIT_RSP) regarding session de-initialization to the host (or framework) 813. The UWBS 811 may transmit a message (SESSION_STATUS_NTF(de-init)) regarding a session status notification according to a status change to the host (or framework) 813. The host (or framework) 813 may transmit a command (Device Deep Power Down) instructing the UWBS 811 to deactivate or power down the UWBS 811.

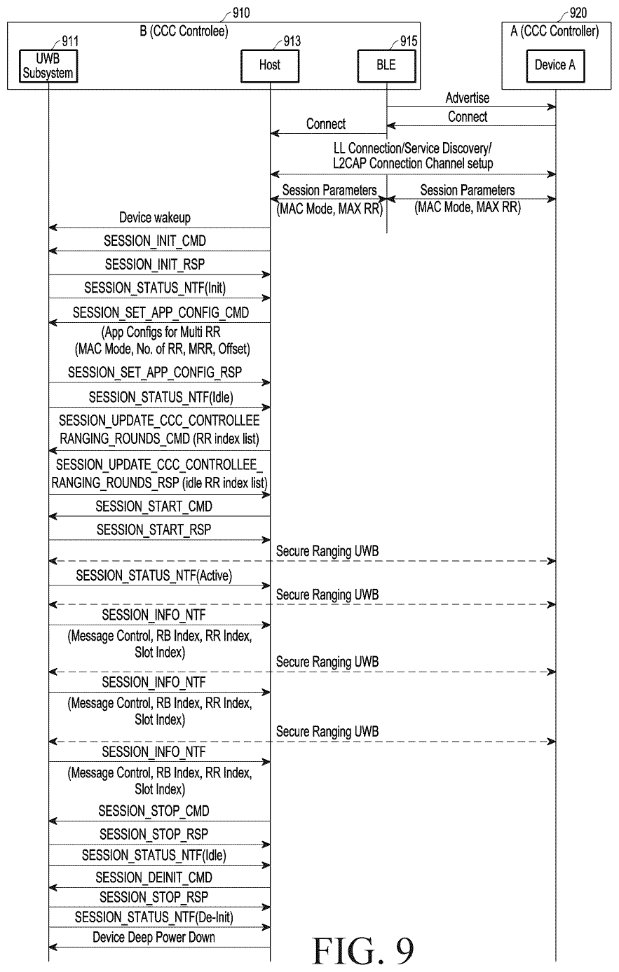

FIG. 9 illustrates a flow diagram depicting a UCI for multi-ranging in a controlee according to an embodiment of the disclosure.

Referring to FIG. 9, a first UWB device (controlee) 910 may include a UWBS 911, a host (or framework) 913, and a BLE module 915.

The BLE module 915 may transmit an advertisement message to a second UWB device (controller) 920 including an anchor, and the second UWB device (controller) 920 may transmit, to the BLE module 915, a message (“connect”) requesting a BLE connection. The BLE module 915 may deliver the message (“connect”) requesting the BLE connection to the host (or framework) 913. The first UWB device (controlee) 910 and the second UWB device (controller) 920 may establish a link layer connection and then sequentially perform service discovery and create an L2CAP connection channel.

The BLE module 915 and the second UWB device (controller) 920 may exchange session parameters (e.g., MAC mode and MAX ranging rounds (RR)) used for UWB ranging session setup through a negotiation scheme in the form of ranging session setup request/response messages. The BLE module 915 and the host (or framework) 913 may also deliver or exchange the session parameters (e.g., MAC mode and MAX RR).

According to an embodiment, the first UWB device (controlee) 910 and the second UWB device (controller) 920 may exchange device capability parameters in order to use multiple ranging rounds (MRR) during UWB TWR. According to an embodiment, the device capability parameters may include at least one of the parameters listed in Table 1.

The host (or framework) 913 may transmit a device wakeup message to the UWBS 911 to wake up the UWBS 911. The host (or framework) 913 may transmit a session initialization command (SESSION_INIT_CMD) to the UWBS 911, and the UWBS 911 may transmit a session initialization response (SESSION_INIT_RSP) to the host (or framework) 913.

The UWBS 911 may transmit a message (SESSION_STATUS_NTF(init)) regarding a session status to the host (or framework) 913, and the host (or framework) 913 may transmit a command (SESSION_SET_APP_CONFIG_CMD) regarding session and application configuration to the UWBS 911. According to an embodiment, the command (SESSION_SET_APP_CONFIG_CMD) regarding session and application configuration may include application configuration information for multiple ranging rounds (RRs). According to an embodiment, the command (SESSION_SET_APP_CONFIG_CMD) regarding session and application configuration may include at least one of MAC mode, the number of RRs, information regarding multiple ranging rounds (MRR), and offset. The UWBS 911 may transmit a response (SESSION_SET_APP_CONFIG_RSP) regarding session and application configuration to the host (or framework) 913.

According to an embodiment, application configuration parameters for use of MRR during UWB TWR may be configured. According to an embodiment, the first UWB device (controlee) 910 and/or the second UWB device (controller) 920 may add associated parameters for MRR when configuring a CCC service. According to an embodiment, the first UWB device (controlee) 910 may configure the number of ranging rounds used for MRR during UWB TWR, and may transmit MRR information to the second UWB device (controller) 920. At this time, an offset may be configured in order to prevent ranging conflicts with another session and to eliminate interference between ranging rounds.

According to an embodiment, the application configuration parameters for use of MRR during UWB TWR may include at least one of the parameters listed in Table 2.

The UWBS 911 may transmit a message (SESSION_STATUS_NTF(idle)) regarding a session status to the host (or framework) 913. The host (or framework) 913 may transmit a command (SESSION_UPDATE_CCC_CONTROLEE_RANGING_ROUNDS_CMD) regarding session update and controlee ranging rounds to the UWBS 911. According to an embodiment, the command (SESSION_UPDATE_CCC_CONTROLEE_RANGING_ROUNDS_CMD) regarding session update and controlee ranging rounds may include an RR index list. The UWBS 911 may transmit a response (SESSION_UPDATE_CCC_CONTROLEE_RANGING_ROUNDS_RSP) regarding session update and controlee ranging rounds to the host (or framework) 913.

According to an embodiment, the command of a session update message of a CCC controlee for multiple ranging rounds (MRR) may include ranging round index information and the number of participating ranging rounds. According to an embodiment, the first UWB device (controlee) 910 may be able to move to the corresponding RR upon occurrence of a hopping condition, based on idle ranging round information included in a response.

According to an embodiment, the host (or framework) 913 may deliver ranging round index information to the UWBS 911 in order to receive UWB messages transmitted from the second UWB device (controller) 920.

According to an embodiment, a command (SESSION_UPDATE_CCC_CONTROLEE_RANGING_ROUNDS_CMD) regarding session update and controlee ranging rounds may include at least one of the fields listed in Table 8.

TABLE 8
SESSION_UPDATE_CCC_CONTROLEE_RANGING_ROUNDS_CMD

| Payload | | | |
|---|---|---|---|
| Field(s) | Length | | Value/Description |
| Session | 4 | Octets | Session Handle of the CCC session whose multiple ranging |
| Handle | | | rounds are to be activated. |
| Number of | 1 | Octet | Number of ranging rounds (N) in which a UWBS is acting as CCC |
| Ranging | | | Controlee. Values can be 1 ≤ N ≤ |
| Rounds | | | CCC_CONTROLEE_MAX_RR. |
| Ranging | N | Octets | List of the N multiple ranging round indexes where the UWBS |

| | |
|---|---|
| Round | shall listen for CCC UWB messages from CCC Controller. |
| Indexes | |

According to an embodiment, a response (SESSION_UPDATE_CCC_CONTROLEE_RANGING_ROUNDS_RSP) regarding session update and controlee ranging rounds may include at least one of the fields listed in Table 9.

TABLE 9
SESSION_UPDATE_CCC_CONTROLEE_RANGING_ROUNDS_RSP

| Payload | | | |
|---|---|---|---|
| Field(s) | Length | | Value/Description |
| Status | 1 | Octet | STATUS_OK for success |
| Number | 1 | Octet | Number of ranging rounds (N) that could be idle. This value should |
| of idle | | | be set to 0x00 if the Status field of the response is STATUS_OK. |
| Ranging | | | Values can be 0 ≤ N ≤ 255 |
| Rounds | | | |
| Idle | N | Octets | List of the N Ranging Round indexes that could be idle |

Ranging
Round
Indexes

The host (or framework) 913 may transmit a command (SESSION_START_CMD) instructing session start to the UWBS 911, and the UWBS 911 may transmit a response (SESSION_START_RSP) instructing session start to the host (or framework) 913.

The first UWB device (controlee) 910 may perform UWB secure ranging with the second UWB device (controller) 920 by using the UWBS 911. The UWBS 911 may transmit a message (SESSION_STATUS_NTF(active)) regarding a session status to the host (or framework) 913.

The first UWB device (controlee) 910 may perform UWB secure ranging with the second UWB device (controller) 920 by using the UWBS 911 through the application configuration and session update as described above with reference to FIG. 7. The UWBS 911 may transmit a message (SESSION_INFO_NTF) regarding a session status to the host (or framework) 913 upon a session status change from idle to active. According to an embodiment, the session information notification (SESSION_INFO_NTF) may include at least one of a next block index, a next ranging round (RR) index, a slot index, and a distance result value.

The first UWB device (controlee) 910 may perform UWB secure ranging with the second UWB device (controller) 920 in the form of MRR by using the UWBS 911. The UWBS 911 may transmit a session information notification (SESSION_INFO_NTF), including ranging result values of the CCC controlee shown in Table 6, to the host (or framework) 913. According to an embodiment, the session information notification (SESSION_INFO_NTF) may include at least one of a next block index, a next ranging round (RR) index, a slot index, and a distance result value.

If necessary, the first UWB device (controlee) 910 may perform UWB secure ranging with the second UWB device (controller) 920 a plurality of times by using the UWBS 911, and the UWBS 911 may transmit, a plurality of times, the session information notification (SESSION_INFO_NTF) to the host (or framework) 913.

According to an embodiment, a ranging measurement message of the second UWB device (controller) 920 may include at least one of the fields listed in Table 6. According to an embodiment, a ranging measurement message of the first UWB device (controlee) 910 may include at least one of the fields listed in Table 7.

The host (or framework) 913 may transmit a command (SESSION_STOP_CMD) instructing session stop to the UWBS 911, and the UWBS 911 may transmit a response (SESSION_STOP_RSP) instructing session stop to the host (or framework) 913.

The UWBS 911 may transmit a message (SESSION_STATUS_NTF(idle)) regarding a session status to the host (or framework) 913. The host (or framework) 913 may transmit a session deinitialization command (SESSION_DEINIT_CMD) to the UWBS 911, and the UWBS 911 may transmit a session deinitialization response (SESSION_DEINIT_RSP) to the host (or framework) 913. The UWBS 911 may transmit a message (SESSION_STATUS_NTF(de-init)) regarding a session status notification upon a session status change to the host (or framework) 913. The host (or framework) 913 may transmit a command (Device Deep Power Down) instructing the UWBS 911 to deactivate or power down the UWBS 911.

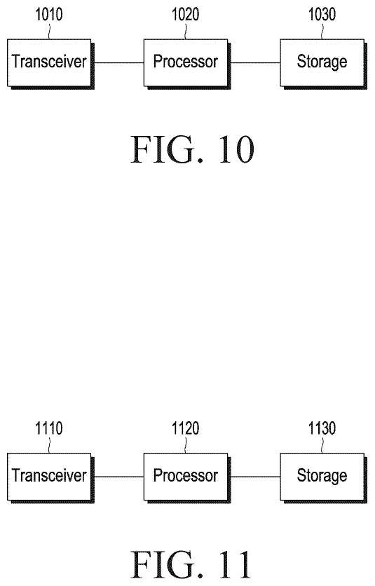

FIG. 10 illustrates a structure of a first UWB device according to an embodiment of the disclosure.

In the embodiment of FIG. 10, the first UWB device may be an electronic device that corresponds to the UWB device of FIG. 1, includes the UWB device, or includes a part of the UWB device. The first UWB device may be implemented as a device operating as a controller during UWB communication as described in FIGS. 1 to 9.

Referring to FIG. 10, the first UWB device may include a transceiver 1010, a processor 1020, and a storage 1030. In the disclosure, the processor may be defined as a circuit, an application-specific integrated circuit, or at least one processor.

The transceiver 1010 may transmit and receive signals to and from another entity.

The processor 1020 may be configured to control overall operations of the first UWB device according to the embodiment proposed in the disclosure. For example, the processor 1020 may be configured to control a signal flow between blocks so as to perform operations according to the flow diagrams described above. Specifically, the processor 1020 may be configured to control operations of the device operating as a controller during UWB communication as described in FIGS. 1 to 9.

The storage 1030 may store at least one of information transmitted/received through the transceiver 1010 and information generated through the processor 1020. For example, the storage 1030 may store information and data used for the method described with reference to FIGS. 1 to 9.

According to an embodiment, a method of a first UWB device operating as a controller during UWB communication may include exchanging, with a second UWB device operating as a controlee, device capability information regarding multiple ranging rounds to be used when the first UWB device and the second UWB device perform UWB TWR, transmitting, by a framework in the first UWB device, a command including a service configuration parameter or a session configuration parameter for the multiple ranging rounds to a UWBS in the first UWB device through a UCI, receiving, by the framework in the first UWB device, a response corresponding to the command from the UWBS in the first UWB device via the UCI, and performing UWB secure ranging with the second UWB device, based on the configuration parameter for the multiple ranging rounds.

According to an embodiment, the configuration parameter for the multiple ranging rounds may include at least one of an indicator indicating whether to use the multiple ranging rounds when performing the UWB TWR, a list of the multiple ranging rounds, the number of the multiple ranging rounds, and an offset for the multiple ranging rounds.

According to an embodiment, the service configuration parameter for the multiple ranging rounds may include at least one of an indicator including whether to use the multiple ranging rounds when performing the UWB TWR and the number of the ranging rounds, the number of the multiple ranging rounds, and an offset for the multiple ranging rounds.

According to an embodiment, the configuration parameter for the multiple ranging rounds may include at least one of an indicator indicating whether to use the multiple ranging rounds when performing UWB TWR, a list of the multiple ranging rounds, the number of multiple ranging rounds, and an offset for the multiple RRs.

According to an embodiment, the method of the first UWB device may further include transmitting, by the UWBS in the first UWB device to the framework in the first UWB device, a block index for the multiple ranging rounds, an index for the multiple ranging rounds, and an index of a ranging slot within the multiple ranging rounds when the UWBS in the first UWB device performs the UWB secure ranging with the second UWB device.

According to an embodiment, the device capability information regarding the multiple ranging rounds may include an indicator indicating whether to use the multiple ranging rounds when performing the UWB TWR, and a maximum number configurable for the multiple ranging rounds.

According to an embodiment, the method of the first UWB device may further include transmitting a list of the multiple ranging rounds to the second UWB device through a UWB pre-poll message, a UWB Final_Data message, or BLE data transfer.

According to an embodiment, the method of the first UWB device may include transmitting, to the second UWB device, a ranging measurement message including list information and an index of the multiple ranging rounds.

FIG. 11 illustrates a structure of a second UWB device according to an embodiment of the disclosure.

In the embodiment of FIG. 11, the second UWB device may be an electronic device that corresponds to the UWB device of FIG. 1, includes the UWB device, or includes a part of the UWB device. The second UWB device may be implemented as a device operating as a controller during UWB communication.

Referring to FIG. 11, the second UWB device may include a transceiver 1110, a processor 1120, and a storage 1130. In the disclosure, the processor may be defined as a circuit, an application-specific integrated circuit, or at least one processor.

The transceiver 1110 may transmit and receive signals to and from another entity.

The processor 1120 may be configured to control overall operations of the device operating as a controlee during UWB communication according to an embodiment of the disclosure. For example, the processor 1120 may be configured to control signal flows among respective blocks to perform operations according to the flow diagrams described above. Specifically, the processor 1120 may be configured to control operations of the device operating as a controlee during UWB communication, as described with reference to FIGS. 1 to 9.

The storage 1130 may store at least one of information transmitted and received through the transceiver 1110 and information generated through the processor 1120. For example, the storage 1130 may store information and data used for the method described with reference to FIGS. 1 to 9.

According to an embodiment, a method of a second UWB device operating as a controlee during UWB communication may include exchanging, with a first UWB device operating as a controller, device capability information regarding multiple ranging rounds to be used when the first UWB device and the second UWB device perform UWB TWR, transmitting, by a framework in the second UWB device, a command including a service configuration parameter or a session configuration parameter for the multiple ranging rounds to a UWBS in the second UWB device through a UCI, receiving, by the framework in the second UWB device, a response corresponding to the command from the UWBS in the second UWB device through the UCI, and performing UWB secure ranging with the first UWB device, based on the configuration parameter for the multiple ranging rounds.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a first ultra-wideband (UWB) device operating as a controller during UWB communication, the method comprising:
exchanging, with a second UWB device operating as a controlee, device capability information regarding multiple ranging rounds to be used when the first UWB device and the second UWB device perform UWB two-way ranging (TWR);
transmitting, by a framework in the first UWB device, a command including a service configuration parameter or a session configuration parameter for the multiple ranging rounds to a UWB subsystem (UWBS) in the first UWB device through a UWB command interface (UCI);
receiving, by the framework in the first UWB device, a response corresponding to the command from the UWBS in the first UWB device through the UCI; and
performing UWB secure ranging with the second UWB device, based on the configuration parameter for the multiple ranging rounds.

2. The method of claim 1, wherein the configuration parameter for the multiple ranging rounds comprises at least one of an indicator indicating whether to use the multiple ranging rounds when performing the UWB TWR, a list of the multiple ranging rounds, a number of the multiple ranging rounds, or an offset for the multiple ranging rounds.

3. The method of claim 1, wherein the service configuration parameter for the multiple ranging rounds comprises at least one of an indicator including whether to use the multiple ranging rounds when performing the UWB TWR and a number of the multiple ranging rounds, the number of the multiple ranging rounds, or an offset for the multiple ranging rounds.

4. The method of claim 1, wherein the session configuration parameter for the multiple ranging rounds comprises at least one of a session handle of a session in which the multiple ranging rounds operate when performing the UWB TWR, a number of the multiple ranging rounds, and a list of the multiple ranging rounds, the list including at least one of a round index, a number of responders, a responder MAC address list, a responder slot scheduling, or responder slots.

5. The method of claim 1, further comprising transmitting, by the UWBS in the first UWB device, a block index for the multiple ranging rounds, an index for the multiple ranging rounds, and an index of a ranging slot within the multiple ranging rounds to the framework in the first UWB device when performing the UWB secure ranging with the second UWB device.

6. The method of claim 1, wherein the device capability information regarding the multiple ranging rounds comprises an indicator indicating whether to use the multiple ranging rounds when performing the UWB TWR, and a maximum number of ranging rounds configurable as the multiple ranging rounds.

7. The method of claim 1, further comprising transmitting a list of the multiple ranging rounds to the second UWB device through a UWB pre-poll message, a UWB final data message, or BLE data transfer.

8. The method of claim 1, further comprising transmitting, to the second UWB device, a ranging measurement message including list information and an index of the multiple ranging rounds.

9. A method of a second ultra-wideband (UWB) device operating as a controlee during UWB communication, the method comprising:
exchanging, with a first UWB device operating as a controller, device capability information regarding multiple ranging rounds to be used when the first UWB device and the second UWB device perform UWB two-way ranging (TWR);
transmitting, by a framework in the second UWB device, a command including a service configuration parameter or a session configuration parameter for the multiple ranging rounds to a UWB subsystem (UWBS) in the second UWB device through a UWB command interface (UCI);
receiving, by the framework in the second UWB device, a response corresponding to the command from the UWBS in the second UWB device through the UCI; and
performing UWB secure ranging with the first UWB device, based on the configuration parameter for the multiple ranging rounds.

10. The method of claim 9, wherein the configuration parameter for the multiple ranging rounds comprises at least one of an indicator indicating whether to use the multiple ranging rounds when performing the UWB TWR, a list of the multiple ranging rounds, a number of the multiple ranging rounds, or an offset for the multiple ranging rounds.

11. The method of claim 9, wherein the service configuration parameter for the multiple ranging rounds comprises at least one of an indicator including whether to use the multiple ranging rounds when performing the UWB TWR and a number of the ranging rounds, the number of the multiple ranging rounds, or an offset for the multiple ranging rounds.

12. The method of claim 9, wherein the session configuration parameter for the multiple ranging rounds comprises at least one of a session handle of a session in which the multiple ranging rounds operate when performing the UWB TWR, a number of the multiple ranging rounds, and a list of the multiple ranging rounds, the list including at least one of a round index, a number of responders, a responder MAC address list, a responder slot scheduling, or responder slots.

13. The method of claim 9, further comprising transmitting, by the UWBS in the second UWB device, a block index for the multiple ranging rounds, an index for the multiple ranging rounds, and an index of a ranging slot within the multiple ranging rounds to the framework in the second UWB device when performing the UWB secure ranging with the first UWB device.

14. The method of claim 9, wherein the device capability information regarding the multiple ranging rounds comprises an indicator indicating whether to use the multiple ranging rounds when performing the UWB TWR, and a maximum number of ranging rounds configurable as the multiple ranging rounds.

15. The method of claim 9, further comprising transmitting a list of the multiple ranging rounds to the first UWB device through a UWB pre-poll message, a UWB final_data message, or BLE data transfer.

16. The method of claim 9, further comprising transmitting, to the first UWB device, a ranging measurement message including list information and an index of the multiple ranging rounds.

17. A first ultra-wideband (UWB) device operating as a controller during UWB communication, the device comprising:
a transceiver; and
a processor operably coupled to the transceiver,
wherein the processor is configured to:
exchange, with a second UWB device operating as a controlee, device capability information regarding multiple ranging rounds to be used when the first UWB device and the second UWB device perform UWB two-way ranging (TWR);
control a framework in the first UWB device to transmit a command including a service configuration parameter or a session configuration parameter for the multiple ranging rounds to a UWB subsystem (UWBS) in the first UWB device through a UWB command interface (UCI);
receive, by the framework in the first UWB device, a response corresponding to the command from the UWBS in the first UWB device through the UCI; and
perform UWB secure ranging with the second UWB device, based on the configuration parameter for the multiple ranging rounds.

18. The device of claim 17, wherein the configuration parameter for the multiple ranging rounds comprises at least one of an indicator indicating whether to use the multiple ranging rounds when performing the UWB TWR, a list of the multiple ranging rounds, a number of the multiple ranging rounds, or an offset for the multiple ranging rounds.

19. A second ultra-wideband (UWB) device operating as a controlee during UWB communication, the device comprising:
a transceiver; and
a processor operably connected to the transceiver,
wherein the processor is configured to:
exchange, with a first UWB device operating as a controller, device capability information regarding multiple ranging rounds to be used when the second UWB device and the first UWB device perform UWB two-way ranging (TWR);
control a framework in the second UWB device to transmit a command including a service configuration parameter or a session configuration parameter for the multiple ranging rounds to a UWB subsystem (UWBS) in the second UWB device through a UWB command interface (UCI);
receive, by the framework in the second UWB device, a response corresponding to the command from the UWBS in the second UWB device through the UCI; and
perform UWB secure ranging with the first UWB device, based on the configuration parameter for the multiple ranging rounds.

20. The device of claim 19, wherein the configuration parameter for the multiple ranging rounds comprises at least one of an indicator indicating whether to use the multiple ranging rounds when performing the UWB TWR, a list of the multiple ranging rounds, a number of the multiple ranging rounds, or an offset for the multiple ranging rounds.
